(19) United States
(12) Patent Application Publication
(10) Pub. No.: US 2009/0277592 A1
(43) Pub. Date: Nov. 12, 2009

(54) Screen apparatus

(76) Inventors: Yasubumi Okachi, Kanagawa (JP); Yuichiro Nishioka, Kanagawa (JP)

Correspondence Address: WENDEROTH, LIND & PONACK, L.L.P., 1030 15th Street, N.W.,, Suite 400 East, Washington, DC, 20005-1503, US

(21) Appl. No.: 12/308,701

(22) PCT Filed: Jun. 21, 2007
(86) PCT No.: PCT/JP2007/062506

§ 371 Date: Apr. 17, 2009

(30) Foreign Application Priority Data
Jun. 23, 2006 (JP) 2006-174566

(51) Int. Cl. E06B 9/24

(52) U.S. Cl. 160/84.06

(57) ABSTRACT

A screen is made to be able to be interchanged in a state in which the screen is made to be detachable from a screen attaching frame portion, a first connector is arranged at one ends extracted from the screen of screen tension members penetrating the screen at a plurality of portions in a length direction, the one end is connected to a vicinity of a free end of a slide guide frame portion, other end of a jump member extracted to a screen attaching side is arranged with a second connector, the first connector and the second connector are made to be attachable and detachable to and from each other, and the slide guide frame portion is extracted from inside of the screen attaching frame portion.

### TECHNICAL FIELD

The present invention relates to a screen apparatus capable of interchanging a screen when the screen is stained or torn or the like.

### BACKGROUND ART

The applicant has provided a screen apparatus as shown in FIG. 7 and FIG. 8 as an apparatus of resolving a restriction in installation when used as light shielding and light dimming means of a curtain, a blind or the like, or a window screen, a partition wall or the like, further, realizing an excellent operability and a shape stability of a screen (Patent Reference 1).

The screen apparatus includes a pair of screen attaching frame portions 1 which are arranged to be opposed to each other and at least one of which is slidingly movable, and the two screen attaching frame portions 1 are attached with a screen 2 to be able to be contracted and developed between the two screen attaching frame portions 1. The screen 2 is formed from, a cloth, a net, a sheet or the like and contracted and developed in accordance with a sliding movement of at least one of the screen attaching frame portions 1. The screen 2 attached with a plurality of pleats is preferably applied.

Further, the screen apparatus includes a slide guide frame portion 3 of guiding the sliding movement of the screen attaching frame portion 1 at a vicinity of at least one of end portions of the screen 2 which is not on a side of being attached to the screen attaching frame portion 1. The slide guide frame portion 3 is continuously provided to be formed with rigid units 4. As shown by FIG. 9, the rigid unit 4 includes a pair of side wall portions 5 arranged opposedly to each other and a bridging portion 6 of connecting the two side wall portions 5 to each other. The rigid unit 4 can include a projection 7 projected to an outer side on a side of one end portion of the side wall portion 5, and include a through hole 8 engageable with the projection 7 on a side of other end portion, and the rigid units 4 can continuously be provided by fitting the projection 7 to the through hole 8 from a side of a back face of the side wall portion 5 between the rigid units 4 contiguous to each other. For example, according to the slide guide frame portion 3 formed by the rigid units 4, the rigid units 4 are made to be pivotable between contiguous ones thereof, and therefore, the slide guide frame portion 3 is provided with a flexibility. As shown by FIG. 8, at least one end of the slide guide frame portion 3 is made to constitute a free end 3a, and is made to be able to be contained to and extracted from inside of the screen attaching frame portion 1.

On the other hand, when the slide guide frame portion 3 is extracted from inside of the screen attaching frame portion 1 in accordance with the sliding movement of the screen attaching frame portion 1, an extracted portion thereof maintains a linearity. In order to maintain the linearity, for example, the rigid unit 4 can be provided with a stepped difference 9 by notching a surface thereof at one end edge portion of the bridging portion 6 and a stepped difference 10 by notching a back face thereof at other end edge portion thereof. The linearity of the slide guide frame portion 3 is realized to be maintained by restricting the rigid units 4 from being pivoted when the stepped difference 10 overlaps the stepped difference 9 between the rigid units 4 contiguous to each other. Further, the rigid unit 4 can be formed with a long hole 12 substantially in a crescent shape capable of receiving a small projection 11 by projecting the small projection 11 to an outer side at the side wall portion 5. In this case, the small projection 11 is inserted to the long hole 12 between the rigid units 4 contiguous to each other, and when the small projection 11 is brought into contact with one end of the long hole 12, the rigid unit 4 is restricted from being pivoted, and the linearity of the slide guide frame portion 3 is maintained.

According to the screen apparatus, the slide guide frame portion 3 of guiding the sliding movement of the screen attaching frame portion 1 is extracted from inside of the screen attaching frame portion 1 in accordance with the sliding movement of the screen attaching frame portion 1, further, contained, and therefore, the slide guide frame portion 3 is not a fixed frame always disposed at a constant position. This resolves a restriction in installation when used as light shielding and light dimming means of a curtain, a blind or the like, or a screen window, a partition wall or the like. Further, the slide guide frame portion 3 is provided with the rigidity and the flexibility with an excellent balance since the slide guide frame portion 3 is formed from the rigid units 4, and an excellent operability and a shape stability of the screen 2 are realized.

Further, according to the screen apparatus, as shown by FIG. 10, the free ends 3a of the pair of slide guide frame portions 3 are connected to each other by a slide guide frame portion tension member 13 provided at inside of the screen attaching frame portion 1 for forming a loop in an 8-like shape, and fold back points 14 of the slide guide frame portion tension member 13 are arranged on a side opposed to a side of attaching the screen 2. For example, a string, a wire or the like is used for the slide guide frame portion tension member 13.

Amounts of moving the pair of slide guide frame portions 3 are made to be substantially equal to each other by the slide guide frame portion tension member 13 and the fold back points 14, and a smooth parallel movement of the screen attaching frame portion 1 is firmly realized.

Further, according to the screen apparatus shown in FIG. 10, although a side of the slide guide frame portion 3 opposed to the free end 3a is made to constitute a fixed line 3b and is fixed to the screen attaching frame portion 1, both ends of the slide guide frame portion 3 can be made to constitute the free ends 3a, in that case, both inner portions of the pair of screen attaching frame portions 1 are provided with the slide guide frame portion tension members 13 of forming the 8-like shape loops, and connected to the free ends 3a of the slide guide frame portion 3 and the fold back points 14 are arranged on the side opposed to the side of attaching the screen 2.

### Patent Reference 1: Japanese Patent No. 3323461

### DISCLOSURE OF THE INVENTION

### Problems that the Invention is to Solve

According to the above-described screen apparatus, as shown by FIG. 11, there is a case in which a plurality of pieces of screen tension members 15 of strings, wires or the like are expanded between the pair of screen attaching frame portions 1 by penetrating the screen 2 at a plurality of portions in a length direction with an object of ensuring a self supportability by supporting the screen 2, further, increasing a face strength of the screen 2 or the like. In this case, the respective screen tension members 15 are folded back at portions of the screen 2 attached to the screen attaching frame portion 1, and further folded back at fold back portions 16 provided on a side of the screen attaching frame portion 1 attached to the screen 2 to thereby generate a predetermined tension. One end of each screen tension member 15 is fixed to a vicinity of the free end 3a of the slide guide frame portion 3.

The following drawback has been found in the screen apparatus arranged with the screen tension member 15.

A stain is brought about at the screen 2 by being used. Although the stain can be wiped to be cleaned off to some degree by using water or a cleaning solution, when there is brought about a stain or a tear which cannot be wiped to be cleaned off, the screen 2 needs to be interchanged. However, when the screen 2 is removed, since the one end of the screen tension member 15 is fixed to the vicinity of the free end 3a of the slide guide frame portion 3, the slide guide frame portion 3 needs to be temporarily extracted from the screen attaching frame portion 1 completely. Further, when a new one of the screen 2 is attached, it is necessary to carry out a wiring operation of hanging the screen tension member 15 around the fold back portion 16 at inside of the screen attaching frame portion 1 and fixing the screen tension member 15 at the vicinity of the free end 3a of the slide guide frame portion 3. The slide guide frame portion 3 cannot be extracted and the screen tension member 15 cannot be wired at a portion of installing the screen apparatus, and therefore, the screen 2 is obliged to be interchanged by removing a total of the screen apparatus and transporting the screen apparatus to an assembly factory. In this way, the interchange of the screen 2 takes time and labor.

The invention has been carried out in view of the above-described situation and it is a problem thereof to provide a screen apparatus facilitating to interchange a screen and capable of interchanging the screen at an installation portion without removing the screen apparatus.

### Means for Solving the Problems

A screen apparatus of the invention is characterized by the following in order to resolve the above-described problem.

First, there is proposed a screen apparatus in which a pair of screen attaching frame portions which are arranged opposedly to each other and at least one of which is slidingly movable are attached with a screen to be able to be contracted and developed between the two screen attaching frame portions, a pair of slide guide frame portions are arranged at vicinities of both end portions of the screen which do not constitute sides of being attached to the screen attaching frame portions, the slide guide frame portion is formed by being continuously provided with a rigid unit having a pair of side wall portions arranged opposedly to each other and a bridging portion connecting the pair of side wall portions pivotably between continuous ones thereof, whereas the slide guide frame portion is provided with a flexibility, at least one end thereof is made to constitute a free end and is made to be contained to and extracted from inside of the screen attaching frame portion, when extracted from inside of the screen attaching frame portion in accordance with a sliding movement of the screen attaching frame portion, an extracted portion of the slide guide frame portion maintains a linearity, further, free ends of the pair of slide guide frame portions are connected to each other by a slide guide frame portion tension member provided at inside of the screen attaching frame portion and forming a loop in an 8-like shape, and fold back points of the slide guide frame portion tension member are arranged on a side opposed to a side of attaching the screen, wherein the screen is made to be detachable from the screen attaching frame portion, a first connector is arranged at one ends extracted from the screen of screen tension members penetrating the screen at a plurality of portions in a length direction, the one end is connected to a vicinity of a free end of the slide guide frame portion, a second connector is arranged at other end of a jump member extracted to the screen attaching side, the first connector and the second connector are made to be attachable and detachable, in a state of extracting the slide guide frame portion from inside of the screen attaching frame portion, the screen is made to be able to be interchanged.

Second, in the above-described invention, a first fold back portion is provided at a portion of the screen attached to the screen attaching frame portion, the screen tension member is hung around the first fold back portion, a direction thereof is changed, a second fold back portion is provided on the screen attaching side of the screen attaching frame portion, the jump member is hung around the second fold back portion, the direction is changed, the first and the second connector which are coupled are made to be movable between the first and the second fold back portions.

Third, in the above-described invention, the first fold back portion is provided at one portion, all of a plurality of pieces of the screen tension members are folded to bend to the first fold back portion, and hung around the first fold back portion.

Fourth, in the above-described invention, the first fold back portion is made to be integral with the screen by being fixed to an attaching portion to the screen attaching frame portion of the screen by making an attaching height thereof adjustable.

### ADVANTAGE OF THE INVENTION

According to the first invention, the screen is detachably attached to the screen attaching frame portion, the first connector arranged at one end of the screen tension member, and the second connector the one end of which is connected to the vicinity of the free end of the slide guide frame portion and which is arranged at the other end of the jump member extracted to the screen attaching side are made to be attachable and detachable, and therefore, the screen can be interchanged in a state of extracting the slide guide frame portion from the screen attaching frame portion to some degree. When the screen is detached from the screen attaching frame portion and the coupling of the first connector and the second connect or is released, the screen can be detached. When a new one of the screen is attached, only the first connector and the second connector may be coupled and only the screen may be attached to the screen attaching frame portion. The screen is interchanged easily, and the screen can be interchanged at a portion of installation without detaching the screen apparatus. Also a user of the screen apparatus can interchange the screen.

According to the second invention, in addition to an effect of the above-described invention, the first fold back portion is provided at the attaching portion to the screen attaching frame portion of the screen, the screen tension member is hung around the first fold back portion, the direction is changed, the second fold back portion is provided at the screen attaching side of the screen attaching frame portion, the jump member is hung around the second fold back portion, the direction is changed, and therefore, in attaching the screen, a complicated wiring is not needed, and interchanging operation is further facilitated. Further, the first and the second connectors which area coupled are made to be movable between the first and the second fold back portions, and therefore, it is not necessary to pass the first, the second connectors respectively through the first, the second fold back portions, the screen tension member and the jump member are smoothly moved in accordance with contraction and development of the screen.

According to third invention, in addition to an effect of the above-described invention, the first fold back portion is provided at one portion, all of the plurality of pieces of the screen tension members are folded to bend to the first fold back portion, and hung around the first fold back portion, and therefore, a portion of the screen which is not related to expansion of the screen tension member can easily be cut, and a size of the screen prepared for maintenance can be reduced.

According to the fourth invention, in addition to the effect of the above-described invention, the first fold back portion is made to be integral with the screen by being fixed to the attaching portion to the screen attaching frame portion of the screen by making the first fold back portion adjustable in the attaching height, and therefore, the first fold back portion can be interchanged simultaneously with interchanging the screen. Although when the first fold back portion is arranged at a lower end portion of the screen, the first fold back portion is easy to be damaged particularly by influence of sand, mud or the like, the fourth invention becomes effective in that case.

### BRIEF DESCRIPTION OF THE DRAWINGS

FIG. 1 is a disassembled perspective view showing an embodiment of a screen apparatus of the invention.

FIG. 2 is a sectional view of an essential portion showing a screen attaching frame portion and a portion of attaching a screen to the screen attaching frame portion according to the embodiment shown in FIG. 1.

FIG. 3 is a perspective view enlarging to show a first fold back portion shown in FIG. 1.

FIG. 4 is an outline constitution view showing the screen attaching frame portion and the portion of attaching the screen to the screen attaching frame portion according to the embodiment shown in FIG. 1.

FIG. 5 is a perspective view enlarging to show a first connector and a second connector shown in FIG. 1.

FIGS. 6 <a><b><c> are respectively sectional views of an essential portion generally showing other embodiments of the screen apparatus of the invention.

FIG. 7 is a side view showing a screen apparatus provided by the applicant.

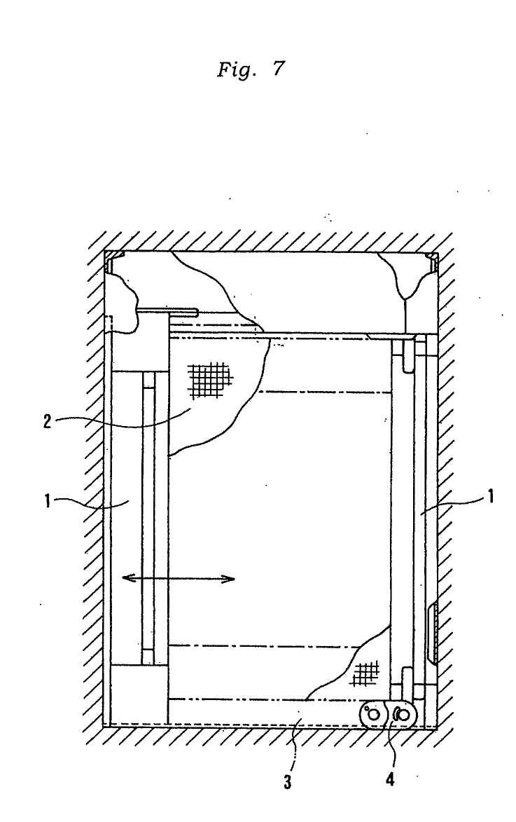

FIG. 8 is a sectional view of an essential portion of the screen apparatus shown in FIG. 7.

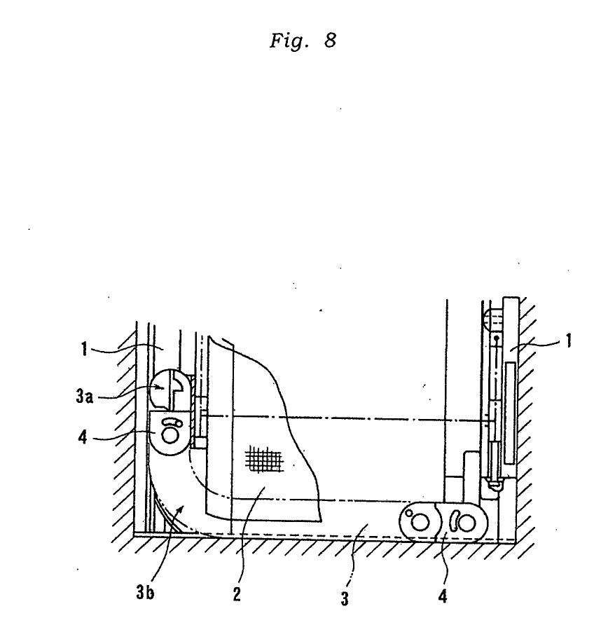

FIGS. 9 <a><b><c><d> are respectively a front view, a side view, a bottom view, and a sectional view taken along a line A-A exemplifying a rigid unit forming a slide guide frame portion of the screen apparatus shown in FIG. 7 and FIG. 8.

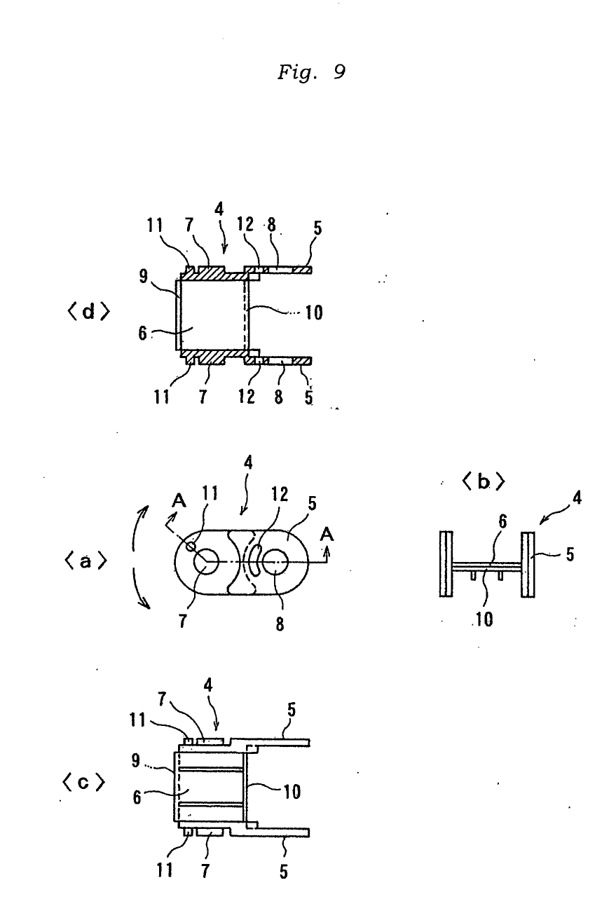

FIG. 10 is a sectional view generally showing an essential portion of the screen apparatus provided by the applicant.

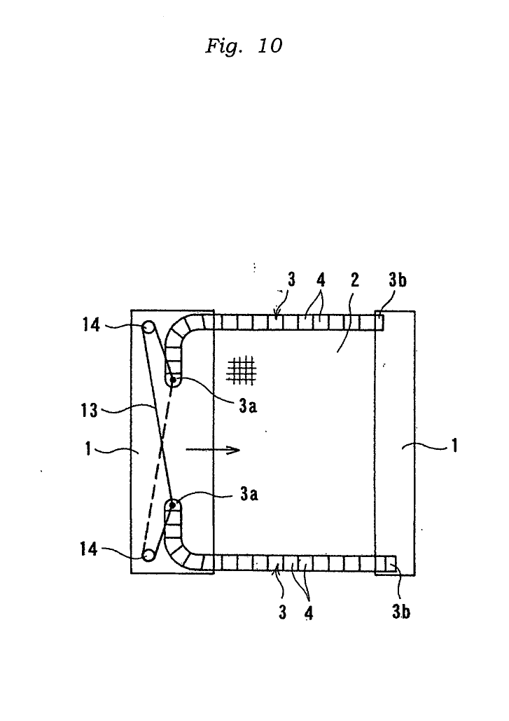

FIG. 11 is a sectional view of an essential portion showing a case of expanding a screen tension member in the screen apparatus shown in FIG. 10.

### DESCRIPTION OF REFERENCE NUMERALS AND SIGNS

1 . . . screen attaching frame portion
2 . . . screen
2a . . . attaching portion
3 . . . slide guide frame portion
3a . . . free end
4 . . . rigid unit
5 . . . side wall portion
6 . . . bridging portion
13 . . . slide guide frame portion tension member
14 . . . fold back portion
15 . . . screen tension member
24 . . . first fold back portion
31 . . . first connector
32 . . . jump member
33 . . . second fold back portion
34 . . . second connector

### BEST MODE FOR CARRYING OUT THE INVENTION

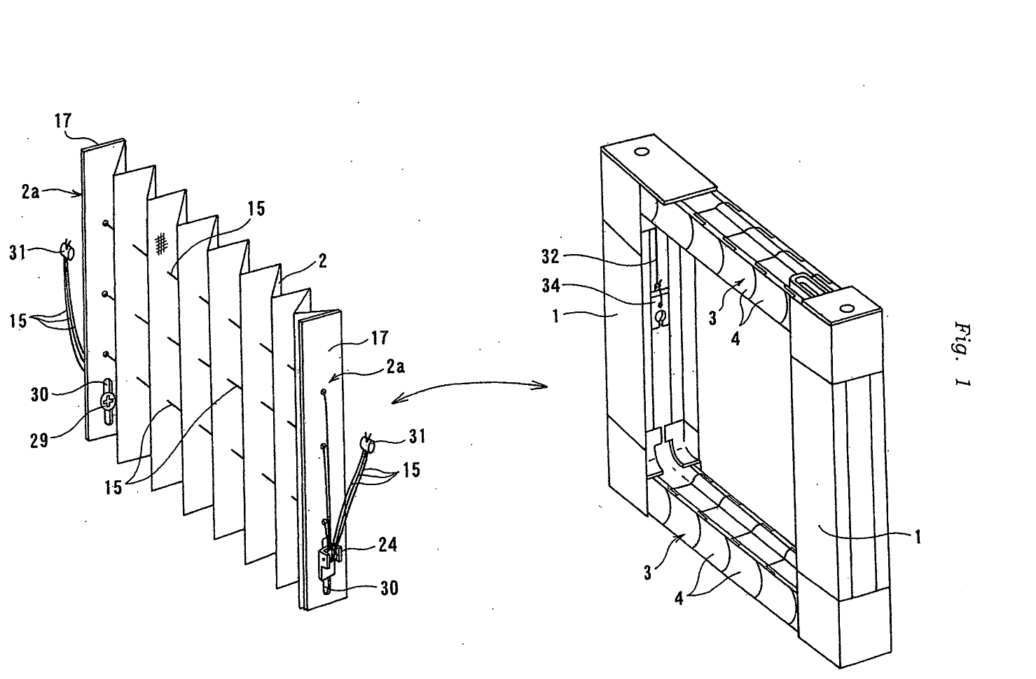

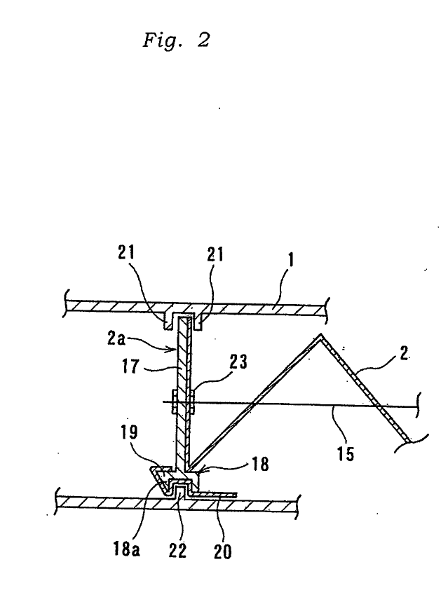

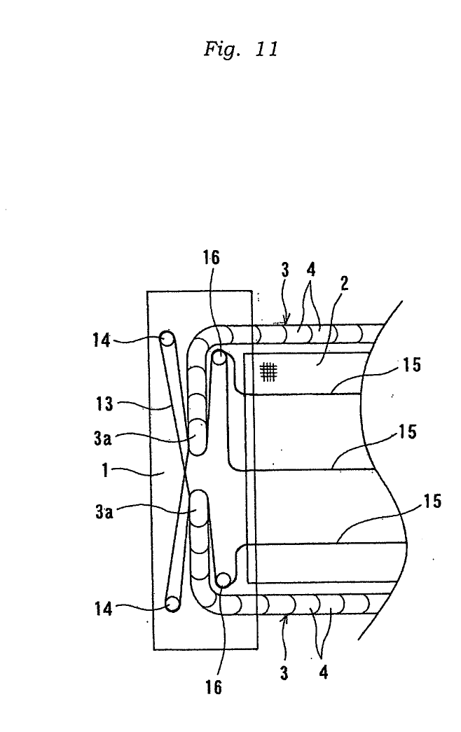

In a screen apparatus shown in FIG. 1 and FIG. 2, portions common to those of the screen apparatus shown in FIG. 11 are attached with the same notations and an explanation thereof will be omitted.

The screen 2 is formed from a cloth, a net, a sheet attached with a plurality of pleats and made to be contractible and developable in an accordion shape. The screen 2 is arranged with 3 pieces of the screen tension members 15 penetrating the screen 2 in a length direction at upper and lower as well as at center portions thereof. As the screen tension member 15, there can be adopted a pertinent one of, for example, a string, a wire or the like capable of generating a tension, ensuring self supportability and increasing a face strength by supporting the screen 2. A number of pieces thereof can pertinently be set in accordance with a height of the screen 2 and can be made to be a plural number of 2 pieces or more.

Further, the screen 2 is made to be detachable from the screen attaching frame portion 1. Attaching plates 17 which can be made of, for example, a resin or the like are fixed by being adhered, pasted or the like to the screen 2 on outer sides of attaching portions 2a at both left and right end portions of the screen 2. As shown by FIG. 2, one end portion in a height direction of the attaching plate 17 is formed with an engaging portion 18 having a section substantially in a channel-like shape. One engaging piece portion 18a of the engaging portion 18 opposed thereto is formed with a claw 19 skewedly projected from an outer side to an inner side. Further, the attaching plate 17 is provided with a detaching piece 20 extended from a back face to a surface of the claw 19 and to an outer side of the engaging portion 18 and along the inner portion of the engaging portion 18. The detaching piece 20 is fixed by being adhered, pasted or the like to the attaching plate 17 at a portion thereof overlapping the engaging portion 18.

When the screen 2 is attached to the screen attaching frame portion 1, the attaching portion 2a is inserted to between two streaks of locking pieces 21 opposed to each other projected from an inner wall face of one of wall portions of the screen attaching frame portion 1 opposed to each other to an inner side at one end portion of the attaching plate 17 in a shape of a flat plate, successively, the attaching plate 17 is bent, the claw 19 is made to ride over one streak of an engaging piece 22 projected from an inner face of other wall portion of the screen attaching frame portion 1 to an inner side, and the engaging piece 22 is engaged with an inner portion of the engaging portion 18. In detaching the screen 2 from the screen attaching frame portion 1, by pulling the detaching piece 18 in a length direction of the screen 2, a periphery of the engaging portion 18 is bent, the claw 19 is made to ride over the engaging piece 22, and an engagement between the engaging portion 18 and the engaging piece 22 is released. Thereafter, the attaching portion 2a on the side of the one end portion of the attaching plate 17 in the shape of the flat plate locked by the locking pieces 21 is drawn.

In this way, the screen 2 is attachable and detachable to and from the screen attaching frame portion 1 and attachment and detachment thereof are facilitated.

As shown by FIG. 2, a portion of the attaching portion 2a of the screen 2 penetrated by the screen tension member 15 is attached with a guide piece 23 in a shape of a circular cylinder to penetrate the attaching plate 17 and head and tail of an end portion of the screen 2 fixed to the attaching plate 17. As shown by FIG. 1, all of 3 pieces of the screen tension members 15 are folded to bend to a lower side and extracted from the screen 2 at the guide pieces 23. The guide piece 23 is finished to a smooth face at an inner face and an inner edge thereof such that friction with the screen tension member 15 is reduced as less as possible. Also the guide piece 23 can be made of a resin.

3 pieces of the screen tension members 15 extracted from the screen 2 are hung around a first fold back portion 24 provided at a lower end portion of the attaching portion 2a to change directions thereof from a lower side to an upper side.

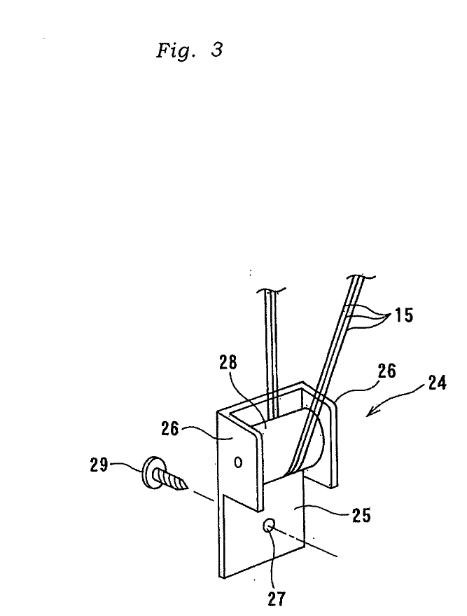

As shown by FIG. 3, the first fold back portion 24 includes a fixing piece 25. A pair of support pieces 26 opposed to each other are extended from both left and right sides of fixing piece 25 from an upper end to a center thereof. A screw hole 27 is formed at the fixing piece 25 on a lower side of the support piece 26. A roller 28 is axially supported between the two support pieces 26, the roller 28 is made to be rotatable. An interval capable of inserting the screen tension member 15 is provided between the roller 28 and the fixing piece 25.

As shown by FIG. 1, the first fold back portion 24 is arranged to bring the fixing piece 25 into contact with the attaching plate 17 fixed to the attaching portion 2a of the screen 2 and direct the support piece 26 to an outer side, and is fixed by screwing a screw 29 from a back side of the attaching plate 17 to the screw hole 27. The attaching portion 2a is formed with a long hole 30 at a lower end portion thereof in a height direction of the screen 2 and a height of attaching the first fold back portion 24 is made to be adjustable. The first fold back portion 24 is made to be integral with the screen 2 by screwing.

3 pieces of the screen tension members 15 are inserted to between the fixing piece 25 and the roller 28 at the first fold back portion 24, and hung around an outer periphery of the roller 28 to change directions from the lower side to the upper side. Further, as shown by FIG. 1, front ends of 3 pieces of the screen tension members 15 are summarized and arranged with a first connector 31.

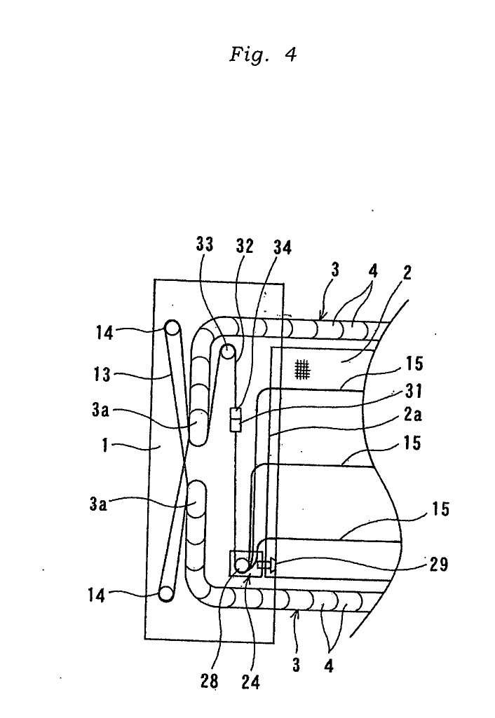

On the other hand, at an inner portion of the screen attaching frame portion 1, as shown by FIG. 4, a jump member 32 is connected to a vicinity of the free end 3a of the slide guide frame portion 3 on an upper side at insides of the pair of slide guide frame portions 3 connected to each other by the slide guide frame portion tension member 13 forming a loop in an 8-like shape. One end thereof is connected to the vicinity of the free end 3a of the slide guide frame portion 3 and other end thereof is extracted to a side of attaching the screen 2. The jump member 32 can be constituted by a wire member of a string, a ribbon, a wire or the like and a material thereof is not particularly restricted.

Further, at the inner portion of the screen attaching frame portion 1, a second fold back portion 33 is provided at an upper portion on the side of attaching the screen 2, the jump member 32 is hung around the second fold back portion 33 to change the direction from the upper side to the lower side and a front end thereof is arranged with a second connector 34. The second connector 34 is made to be attachable and detachable to and from the first connector 31. Therefore, the screen tension member 15 is made to be able to be connected to and released from the slide guide frame portion 3 by way of the jump member 32 by attaching and detaching the first connector 31 and the second connector 34 and connecting and releasing thereof are facilitated. The first connector 31 and the second connector 34 which are coupled are disposed between the first fold back portion 24 and the second fold back portion 33 and made to be movable between the two fold back portions 24, 33.

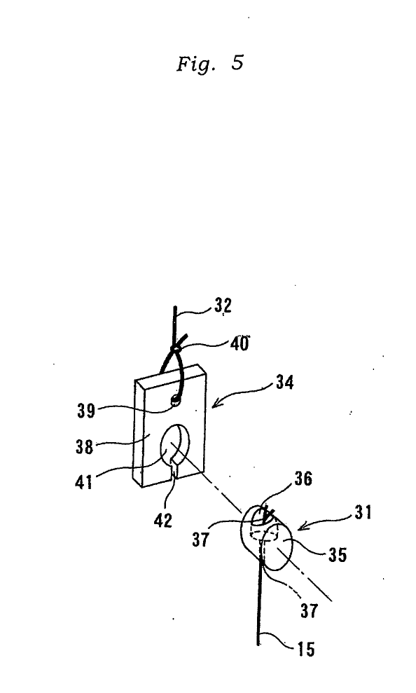

As shown by FIG. 5, the first connector 31 includes an engaging member 35 having substantially a shape of a circular cylinder. A recess portion 36 is formed from a center portion of an upper portion to a center portion of an inner portion of the fitting member 35. A through hole 37 penetrating the fitting member 35 is formed from a bottom face of the recess portion 36, the screen tension member 15 is passed through the recess portion 36 by way of the through hole 37, a ring knot 37 is produced, and the first connector 31 is arranged at the front end of the screen tension member 15.

The second connector 34 includes a main body 38 in a plate-like shape. An upper end portion of the main body 38 is formed with a through hole 39 penetrating head and tail of the main body 38, the jump member 32 is passed through the through hole 39 from the back side to the surface side, and the second connector 34 is arranged at the front end of the jump member 32 by a ring knot 40. A lower end portion of the main body 39 is formed with a fitting hole 41 in a circular shape having an inner diameter substantially the same as or slightly smaller than an outer diameter of the engaging member 35 of the first connector 31, and a notch 42 is formed from a lower end of the fitting hole 41 to a lower end of the main body 38.

Both of the first connector 31 and the second connector 34 can be made of, for example, a resin. When the first connector 31 and the second connector 34 are coupled, the fitting member 35 is press-fit to the fitting hole 41. An interval of the notch 42 is widened, the fitting hole 41 is deformed to an outer side in accordance therewith, and the fitting member 35 is fitted to the fitting hole 41. The first connector 31 and the second connector 34 are coupled in one touch manner and firmly. When the coupling is released, the fitting member 35 is extruded from the fitting hole 41. The coupling is released easily.

According to the above-described screen apparatus, the screen 2 is detachably attached to the screen attaching frame portion 1, the first connector 31 arranged at one end of the screen tension member 15, and the second connector 34 one end of which is connected to the vicinity of the free end 3a of the slide guide frame portion 3 and which is arranged at other end of the jump member 32 extracted to the side of attaching the screen 2 are made to be attachable and detachable, and therefore, the screen 2 can be interchanged in a state of extracting the slide guide frame portion 3 from the screen attaching frame portion 1 to some degree. When the screen 2 is detached from the screen attaching frame portion 1 and coupling of the first connector 31 and the second connector 34 is released, the screen 2 can be detached. When a new one of the screen 2 is attached, the first connector 31 and the second connector 34 may only be coupled and the screen 2 may only attached to the screen attaching frame portion 1. It is easy to interchange the screen 2, and the screen 2 can be interchanged at a portion of installation without detaching the screen apparatus. Also a user of the screen apparatus can interchange the screen 2.

Further, the first fold back portion 24 is provided at the attaching portion 2a to the screen attaching frame portion 1 of the screen 2, the screen tension member 15 is hung around the first fold back portion 24, the direction is changed, the second fold back portion 33 is provided on the side of attaching the screen 2 of the screen attaching frame portion 1, the jump member 32 is hung around the second fold back portion 33, the direction is changed, and therefore, in attaching the screen 2, complicated wiring is dispensed with, and the interchanging operation is further facilitated. Further, the first connector 31 and the second connector 34 which are coupled are made to be able to move between the first fold back portion 24 and the second fold back portion 33, and therefore, it is not necessary to pass the first connector 31, the second connector 34 respectively through the first fold back portion 24, the second fold back portion 33, and the screen tension member 15 and the jump member 32 are smoothly moved in accordance with contraction and development of the screen 2.

Further, the first fold back portion 24 is provided at a portion of a lower end portion of the attaching portion 2a of the screen 2, all of 3 pieces of the screen tension members 15 are folded to bend to the first fold back portion 24, and hung around the first fold back portion 24, and therefore, a portion of the screen 2 which is not related to expansion of the screen tension member 15 can easily be cut, and a size of the screen 2 prepared for maintenance can be reduced.

Furthermore, the first fold back portion 24 is made to be integral with the screen 2 by being fixed to the attaching portion 2a of the screen 2 by making the attaching height adjustable, and therefore, the first fold back portion 24 can be interchanged simultaneously with interchanging the screen 2. Although when the first fold back portion 24 is arranged at the lower end portion of the screen 2, the first fold back portion 24 is easy to be damaged particularly by an influence of sand, mud or the like, also the first fold back portion 24 can be interchanged.

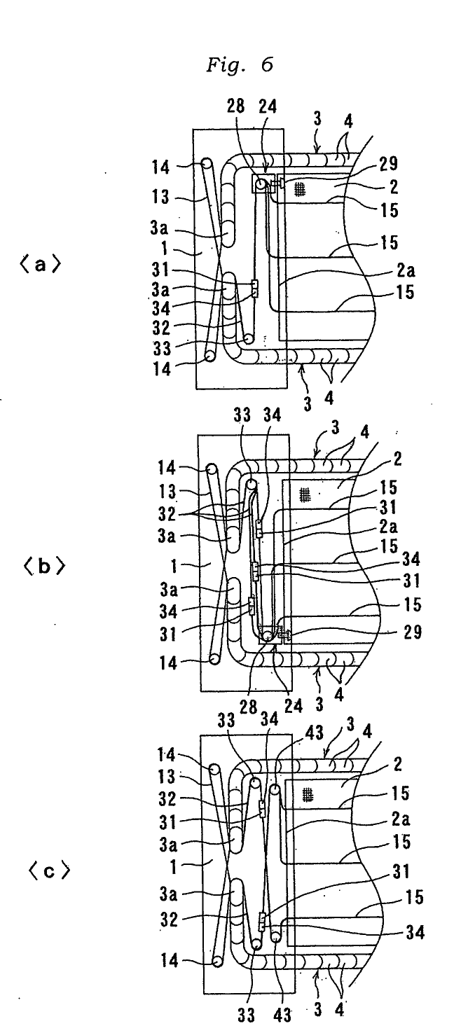

In the screen apparatus shown FIGS. 6 <a><b><c>, portions common to those of the screen apparatus shown in FIG. 4 are attached with the same notations and an explanation thereof will be omitted.

The screen apparatus shown in FIG. 6 <a> differs from the embodiment shown in FIG. 4 in that the first fold back portion 24 is provided at the upper end portion of the attaching portion 2a of the screen 2, the direction of the screen tension member 15 hung around the outer periphery of the roller 28 of the first fold back portion 24 is changed from the upper side to the lower side, further, at the inner portion of the screen attaching frame portion 1, the one end of the jump member 32 is connected to the vicinity of the free end 3a of the slide guide frame portion 3 on the lower side, the second fold back portion 33 is provided at the lower end portion on the side of attaching the screen 2, and the direction of the jump member 32 is changed from the lower side to the upper side. However, also the screen apparatus shown in FIG. 6 <a> achieves an effect similar to that of the screen apparatus shown in FIG. 4.

According to the screen apparatus shown in FIG. 6 <b>, 3 pieces of the screen tension members 15 are not summarized, respective front ends thereof are provided with the first connectors 31, also 3 pieces of the jump members 32 of a number the same as that of the screen tension members 15 are provided, respective front ends thereof are provided with the second connectors 34, and the first connectors 31 and the second connectors 34 are individually attached and detached. Although more or less time and labor are taken for attaching and detaching the first connector 31 and the second connector 34, except thereof, also the screen apparatus shown in FIG. 6 <b> achieves an effect similar to that of the screen apparatus shown in FIG. 4.

According to the screen apparatus shown in FIG. 6 <c>, the first fold back portion 24 is not provided at the attaching portion 2a of the screen 2, third fold back portions 43 are provided on upper and lower sides of the side of attaching the screen 2 at the inner portion of the screen attaching frame portion 1, 2 pieces of the screen tension members 15 penetrating an upper portion and a center portion of the screen 2 are hung around the third fold back portion 43 on the upper side, the directions are changed from the upper side to the lower side, 2 pieces thereof are summarized and a front end thereof is provided with the first connector 31. 1 piece of the screen tension member 15 penetrating the lower portion of the screen 2 is hung around the third fold back portion 43 on the lower side, the direction is changed from the lower side to the upper side, and the front end is provided with the first connector 31.

Further, the second fold back portions 33 are provided on upper and lower sides of the side of attaching the screen 2 at the inner portion of the screen attaching frame portion 1, the jump member 32 one end of which is connected to the free end 3a of the slide guide frame portion 3 on the upper side is hung around the second fold back portion 33 on the upper side, the direction is changed from the upper side to the lower side, and the front end is arranged with the second connector 34. The jump member 32 one end of which is connected to the free end 3a of the slide guide frame portion 3 on the lower side is hung around the second fold back portion 33 on the lower side, the direction is changed from the lower side to the upper side, and the front end is arranged with the second connector 34.

Although according to the screen apparatus shown in FIG. 6 <c>, there is needed an operation of carrying out attachment and detachment of the first connectors 31 and the second connectors 34 at two portions, hanging the screen tension members 15 around the third fold back portions 43, wiring the screen tension members 15 and detaching the screen tension members 15 from the third fold back portions 43 in interchanging the screen 2, the screen 2 can be interchanged in a state of extracting the slide guide frame portion 3 from the screen attaching frame portion 1 to some degree. The screen 2 can be interchanged at the portion of installation without detaching the screen apparatus. Further, the first connector 31 and the second connector 34 which are coupled are made to be movable between the first fold back portion 24 and the second fold back portion 33, and therefore, it is not necessary to pass the first connector 31, the second connector 34 respectively through the first fold back portion 24, the second fold back portion 33, and the screen tension member 15 and the jump member 32 are smoothly moved in accordance with contraction and development of the screen 2.

Further, although the above-described embodiment is a screen apparatus of a horizontals pulling type, the screen apparatus of the invention may be of a vertical pulling type, in that case, the screen apparatus of the vertical pulling type can be constituted quite similar to the screen apparatus of the horizontal pulling type.

### INDUSTRIAL APPLICABILITY

The screen apparatus facilitating to interchange the screen and capable of interchanging the screen at the portion of installation without detaching the screen apparatus is provided by the invention.

1. A screen apparatus characterized in that a pair of screen attaching frame portions which are arranged opposedly to each other and at least one of which is slidingly movable are attached with a screen to be able to be contracted and developed between the two screen attaching frame portions, a pair of slide guide frame portions are arranged at vicinities of both end portions of the screen which do not constitute sides of being attached to the screen attaching frame portions, the slide guide frame portion is formed by being continuously provided with a rigid unit having a pair of side wall portions arranged opposedly to each other and a bridging portion connecting the pair of side wall portions pivotably between continuous ones thereof, whereas the slide guide frame portion is provided with a flexibility, at least one end thereof is made to constitute a free end and is made to be contained to and extracted from inside of the screen attaching frame portion, when extracted from inside of the screen attaching frame portion in accordance with a sliding movement of the screen attaching frame portion, an extracted portion of the slide guide frame portion maintains a linearity, further, free ends of the pair of slide guide frame portions are connected to each other by a slide guide frame portion tension member provided at inside of the screen attaching frame portion and forming a loop in an 8-like shape, and fold back points of the slide guide frame portion tension member are arranged on a side opposed to a side of attaching the screen, wherein the screen is made to be detachable from the screen attaching frame portion, a first connector is arranged at one ends extracted from the screen of screen tension members penetrating the screen at a plurality of portions in a length direction, the one end is connected to a vicinity of a free end of the slide guide frame portion, a second connector is arranged at other end of a jump member extracted to the screen attaching side, the first connector and the second connector are made to be attachable and detachable, in a state of extracting the slide guide frame portion from inside of the screen attaching frame portion, the screen is made to be able to be interchanged.

2. The screen apparatus according to claim 1, characterized in that a first fold back portion is provided at a portion of the screen attached to the screen attaching frame portion, the screen tension member is hung around the first fold back portion, a direction thereof is changed, a second fold back portion is provided on the screen attaching side of the screen attaching frame portion, the jump member is hung around the second fold back portion, the direction is changed, the first and the second connector which are coupled are made to be movable between the first and the second fold back portions.

3. The screen apparatus according to claim 2, characterized in that the first fold back portion is provided at one portion, all of a plurality of pieces of the screen tension members are folded to bend to the first fold back portion, and hung around the first fold back portion.

4. The screen apparatus according to claim 2, characterized in that the first fold back portion is made to be integral with the screen by being fixed to an attaching portion to the screen attaching frame portion of the screen by making an attaching height thereof adjustable.

5. The screen apparatus according to claim 3, characterized in that the first fold back portion is made to be integral with the screen by being fixed to an attaching portion to the screen attaching frame portion of the screen by making an attaching height thereof adjustable.
